(19) United States
(12) Patent Application Publication
(10) Pub. No.: US 2005/0083787 A1
(43) Pub. Date: Apr. 21, 2005

(54) Vertical time watch

(76) Inventors: Ellen Catherine Perez, Santo Domingo (DO); Thomas H. Perez, San Juan, PR (US)

Correspondence Address: Ellen Catherine Perez;BM 1896, Suite A., 6911 N.W. 87th Ave, Miami, FL, 33178, US

(21) Appl. No.: 10/844,615

(22) Filed: Apr. 30, 2004

(30) Foreign Application Priority Data
Mar. 22, 2002 (CH) 128695 CLASSE 10.

(51) Int. Cl. G04C 17/00; G04B 19/00

(52) U.S. Cl. 368/223

(57) ABSTRACT

The object of the “Vertical Time Watch” or clock is to provide a timepiece that provides a vertically scaled, and therefore linearly graphic, time measurement device which is both esthetically appealing and easy to read, in addition to its conceptual novelty. The hands, bands or indicators run along the vertical scales detailed on the dial or face, or along separate lengthwise channels differentiating hours, minutes, seconds, quarter hours, or other time categories. The watch mechanism may be either mechanical (rotating front and back or by resorts), electronic (LCD or other illuminating technology) or any other.

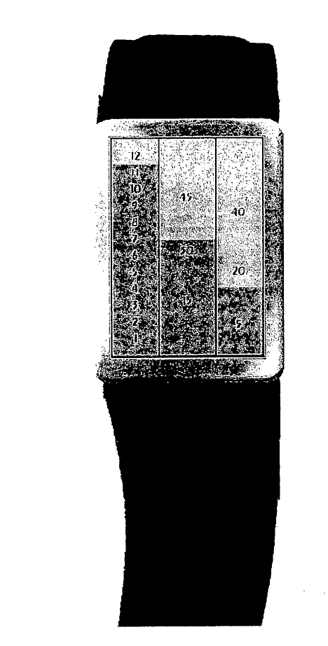

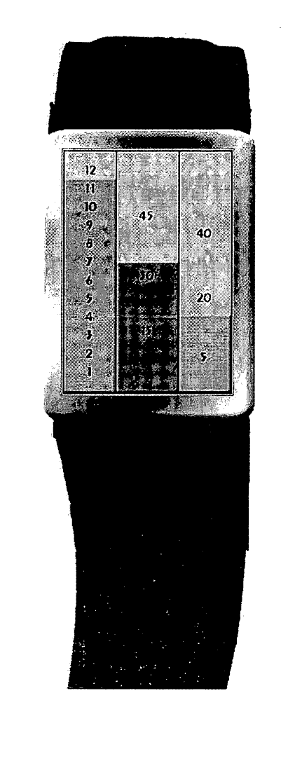

### CROSS REFERENCE TO RELATED APPLICATIONS

1. Field of the Invention

The field of the invention relates generally to watches and clocks, and, more particularly to a vertically scaled time-telling device.

2. Description of Related Art

The watch and time-telling industry is a dynamic one always in search of innovative but practical design. The absence of these is supplied in part by the increasing addition of precious materials in order to create novelty and value. The models have up to now been circumscribed to circularly scaled timepieces. Vertical scaling, different and novel, provides a simple to read mechanism with the added advantage of the beauty of modern design.

A search of prior art shows that all patents relate to circularly scaled timepieces and therefore did not disclose any patents that anticipate this instant invention.

3. Related Applications or Disclosures

The present invention was deposited for design protection by the same inventor on Mar. 22, 2002 at the Swiss Federal Institute of Intellectual Property and accorded protection under the certification number 128695.

### SUMMARY

The “Vertical Time Watch” is a time-telling device that shows time on a vertical scale versus a circular one. The hands or indicators of the watch therefore ascend or descend these vertically oriented scales to show hours, minutes, seconds or other categories of time. This is achieved by any watch or clock movement or illumination method including, but not limited to, resort motion, rotation of hands or bands (over the front and around the back of the linear scale), electronic imaging such as liquid crystal or others. Decorative items may also be added.

### DESCRIPTION OF DRAWINGS

Drawing 1 shows a vertically scaled time-telling device or watch with numbered watch case and side aligned or attached hands which mark the corresponding category of time (hours, minutes or other. Includes a vertical (traditional) or horizontal wrist bracelet.

Drawing 2 shows a vertically scaled time-telling device or watch with a numbered watch face and moving indicators which mark the corresponding category of time (hours, minutes or other. Includes a vertical (traditional) or horizontal wrist bracelet.

### DETAILED DESCRIPTION

The “Vertical Time Watch” is a time-telling device whose distinguishing feature is the lecture of time through a vertically oriented (linear rather than circular) scale. Such scale may be represented by numbering or symbols, on the face or dial, and serve as a reference point for the position of the hands, bands or any other indicating device. The hands or indicating device may ascend or descend according to design (many of the drawings show hours rising—as do the sun and moon during a day—and the minutes descending as they flow by us, but this is not exclusively so).

Time is, therefore, both read through the position of the hands or of bands in relation to the marked scales and as a graphic proportion of the total linear scale covered by or covering the scale on the dial and face or face channels.

The resulting combinations of graphic alignments of hands and/or bands provide an esthetically modem view of time-telling which may be further enhanced with the addition of decorative elements, attached and/or connected to the hands, or free floating within the face and the face cover and limited, if necessary, by raised components such as lines, channels dividers, the relief of a brand-name or others.

In conclusion, the present invention has been described in terms of its general principle (vertically scaled time-telling) variations of which may become obvious to those skilled in this particular area of manufacture and art. Accordingly, it should be understood that the ensuing claims are intended to cover all changes and modifications of the specific illustrative embodiments which fall within the literal scope of the claims and all equivalents thereof.

1. A timepiece with vertical scales for time measurement, comprising:
a watch movement piece (mechanical, electric, LCD or any other);
a dial in any shape, including lines and curves, with vertically scaled numbering or time-telling symbols;
a face with numbering or symbols, which may be divided itself into scales, color sections or vertical channels, including raised dividers which serve as time-telling references;
one or more indicators (hands, bands of shading or any other) which move vertically (lengthwise) with reference to the scales.
These may be physically attached or visually aligned to the sides, center or any other dividing line; and move through revolving, resorting, electronic or any other methods;
a time setting/adjustment means;
a bracelet which may be fastened vertically (in traditional style across the arm) or horizontally (so the watch lies along the arm facing the user).
